(19) United States
(12) Patent Application Publication
(10) Pub. No.: US 2019/0258945 A1
(43) Pub. Date: Aug. 22, 2019

(54) FAULT DIAGNOSIS APPARATUS AND MACHINE LEARNING DEVICE

(71) Applicant: FANUC CORPORATION, Yamanashi (JP)

(72) Inventors: Hideyuki FUKUDA, Yamanashi (JP); Taku SASAKI, Yamanashi (JP)

(21) Appl. No.: 16/280,292

(22) Filed: Feb. 20, 2019

(30) Foreign Application Priority Data
Feb. 22, 2018 (JP) 2018-030138

(51) Int. Cl. G06N 5/04; G06N 20/00; G06N 3/04; G05B 23/02

(52) U.S. Cl. CPC G06N 5/04; G05B 23/0272; G06N 3/04; G06N 20/00

(57) ABSTRACT

A fault diagnosis apparatus is provided with a machine learning device, and the machine learning device observes at least one of fault time point data including information at the occurrence of a fault of a motor drive apparatus to be repaired, and operating environment data indicating an operating environment, operating history data indicating an operating history, as a state variable representing the present state of the environment; acquires repaired and/or replaced part data indicating a part that has been repaired and/or replaced in the motor drive apparatus as label data; and performs learning by associating the observed state variable with the acquired label data.

### RELATED APPLICATIONS

The present application claims priority to Japanese Patent Application Number 2018-030138 filed Feb. 22, 2018, the disclosure of which is hereby incorporated by reference herein in its entirety.

### BACKGROUND OF THE INVENTION

### 1. Field of the Invention

The present invention relates to a fault diagnosis apparatus and a machine learning device, and in particular, to a controller and a machine learning device that specifies a faulty part of a motor drive apparatus.

### 2. Description of the Related Art

In a case where a motor drive apparatus used in a machine tool or the like is faulty, in general, the motor drive apparatus is repaired by replacing a faulty part with a normal part after the faulty part is specified, and is reused. At that time, in order to specify the faulty part, it is traditional to perform repair depending on human experience from appearance and test results. Also, there is provided a tester that performs only testing for only checking for a presence or absence of a fault of a specified part and specifies a spot to be repaired from the results (for example, see Japanese Patent Application Laid-Open Nos. 2001-119987 and 10-020001).

However, in manually-performed fault diagnosis, there is a problem that there is a difference in speed and accuracy in the case of specifying a spot to be repaired depending on the experience of an operator and the like. Also, even though the tester is used, in a case where the number of parts of a product is large or there are many fault modes, there are problems that a type of the tester increases, diagnosis time becomes longer, and the accuracy is reduced. Further, even though test items and test conditions are optimized in order to make a work uniform, it takes time for the work itself. In any case, it is difficult to specify whether a plurality of parts are damaged, or which part is broken down or is faulty.

### SUMMARY OF THE INVENTION

Therefore, an object of the present invention is to provide a fault diagnosis apparatus and a machine learning device which are capable of rapidly diagnosing which spot of a motor drive apparatus is faulty, with high accuracy.

According to embodiments, there is provided a fault diagnosis apparatus which includes a machine learning device for learning parts replacement and test results in a trial and error manner such that it is possible to rapidly and accurately specify the faulty part according to a state of the faulty motor drive apparatus (including an amplifier), so that problems as described above are solved.

With respect to a motor drive apparatus returned due to a fault in the field, the fault diagnosis apparatus according to the embodiments, performs machine learning of, in the product,

(1) information at the occurrence of a fault (alarm information, load information of motor, temperature, time band, and the like), (2) operating environment information (heat sink temperature, temperature, humidity, a cutting fluid situation, a fault situation of other machines, and the like), (3) operating history, (4) test results at the tester (appearance (cutting fluid, a chip adhesion situation), a current, heat generation, an encoder waveform, an internal state of an LSI, and the like), (5) a correspondence relationship between a fault and a replaced part based on information on the repaired and/or replaced part, and the like; and

specifies a faulty part to be replaced using the learned results.

According to the embodiments, in a learning stage of the fault diagnosis apparatus, the item (5) (information on the replaced part) is learned as teacher data whenever parts replacement and testing are repeatedly performed by using the items (1), (2) and (3) as fixed input data, or using the item (4) (test results) as optional input data. On the other hand, according to the embodiments, in an inferring stage of the fault diagnosis apparatus, the faulty part is inferred based on the data of the items (1), (2), (3) (and optional (4)).

According to one embodiment, there is provided a fault diagnosis apparatus for inferring a part to be repaired and/or replaced of a motor drive apparatus, the apparatus including: a machine learning device for learning a part to be repaired and/or replaced with respect to a state of the motor drive apparatus to be repaired. Then, the machine learning device includes a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment; a label data acquisition unit for acquiring repaired and/or replaced part data indicating a part that has been repaired and/or replaced in the motor drive apparatus as label data; and a learning unit for performing learning by associating the state variable with the label data.

The state observation unit may further observe test result data indicating test results of the motor drive apparatus as a state variable.

The label data acquisition unit may further acquire re-repair time data indicating an operating time until a next fault after repairing the motor drive apparatus and starting re-operation, and the next repaired and/or replaced part data indicating information on apart to be repaired and/or replaced at the next fault as label data.

The learning unit may include an error calculating unit for calculating an error between a correlation model for inferring the part to be repaired and/or replaced from the state variable and a correlation feature identified from preliminarily prepared teacher data; and a model updating unit for updating the correlation model to reduce the error.

The learning unit may calculate the state variable and the label data in a multilayer structure.

The machine learning device may be provided in a cloud server.

According to another embodiment, there is provided a fault diagnosis apparatus for inferring a part to be repaired and/or replaced of a motor drive apparatus, the apparatus including: a machine learning device for learning a part to be repaired and/or replaced with respect to the state of the motor drive apparatus to be repaired. Then, the machine learning device includes a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment; a learning unit for performing learning by associating a part that has been repaired and/or replaced in the motor drive apparatus with information at the occurrence of a fault of the motor drive apparatus, an operating environment of the motor drive apparatus, and an operating history of the motor drive apparatus; and an inference result output unit for outputting the results obtained by inferring the part to be repaired and/or replaced, based on a state variable observed by the state observation unit and learning results by the learning unit.

According to one embodiment, there is provided a machine learning device for learning a part to be repaired and/or replaced with respect to an operating situation of a motor drive apparatus to be repaired, the device including: a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment; a label data acquisition unit for acquiring repaired and/or replaced part data indicating a part that has been repaired and/or replaced in the motor drive apparatus as label data; and a learning unit for performing learning by associating the state variable with the label data.

According to another embodiment, there may be provided a machine learning device for learning a part to be repaired and/or replaced with respect to an operating situation of a motor drive apparatus to be repaired, the device including: a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment; a learning unit for performing learning by associating a part that has been repaired and/or replaced in the motor drive apparatus with information at the occurrence of a fault of the motor drive apparatus, an operating environment of the motor drive apparatus, and an operating history of the motor drive apparatus; and an inference result output unit for outputting the results obtained by inferring the part to be repaired and/or replaced, based on a state variable observed by the state observation unit and learning results by the learning unit.

In the fault diagnosis apparatus according to the embodiments, since it is possible to rapidly and accurately specify the faulty part, a time required for repairing the motor drive apparatus may be shortened. Also, it becomes possible to specify and replace a damaged part, and the reliability of the repaired product is increased.

### BRIEF DESCRIPTION OF THE DRAWINGS

FIG. 1 is a schematic hardware configuration diagram of a fault diagnosis apparatus according to a first embodiment;

FIG. 2 is a schematic functional block diagram of the fault diagnosis apparatus illustrated in FIG. 1;

FIG. 3 is a diagram illustrating an example of the learning procedures of the fault diagnosis apparatus illustrated in FIG. 2;

FIG. 4 is a diagram illustrating an example of a state variable S and label data L acquired by the fault diagnosis apparatus illustrated in FIG. 2;

FIG. 5 is a diagram illustrating an example of the learning procedures of the fault diagnosis apparatus illustrated in FIG. 2;

FIG. 6 is a schematic functional block diagram illustrating a fault diagnosis apparatus in a form different from that of the fault diagnosis apparatus illustrated in FIG. 2;

FIG. 7A is a diagram for describing a neuron; and

FIG. 7B is a diagram for describing a neural network.

### DETAILED DESCRIPTION OF THE PREFERRED EMBODIMENTS

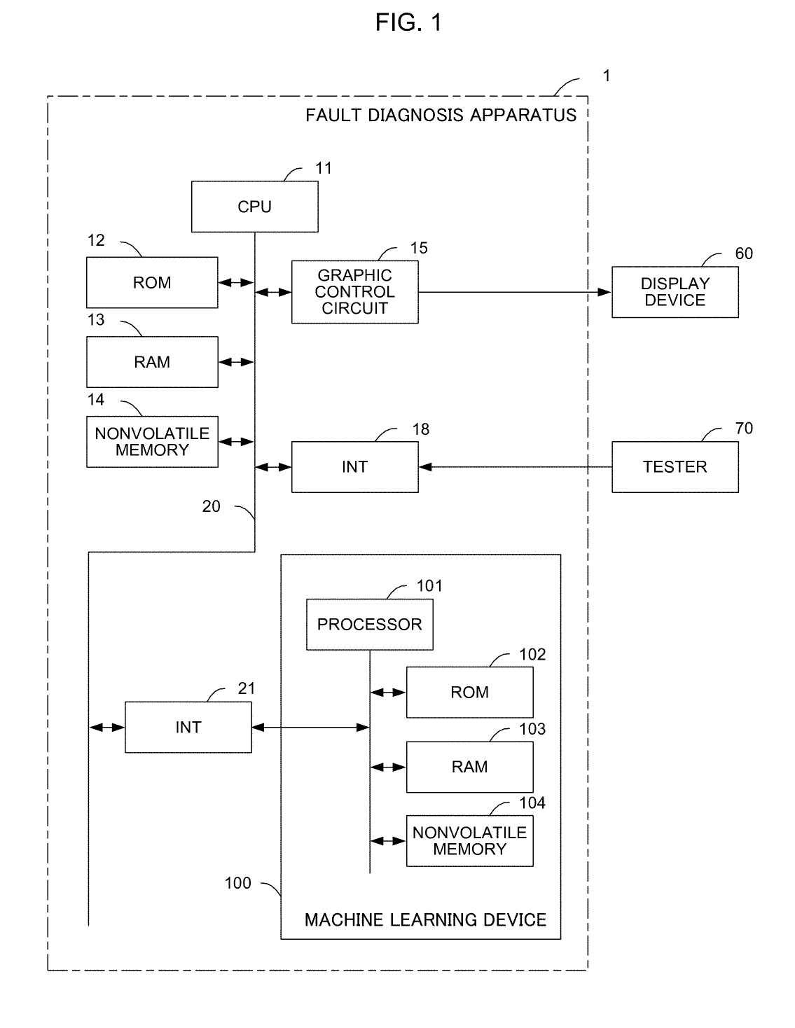

FIG. 1 is a schematic hardware configuration diagram illustrating the main part of a fault diagnosis apparatus according to a first embodiment.

For example, it is possible to implement the fault diagnosis apparatus 1 as a computer (not illustrated) or the like installed in a repair shop of a motor drive apparatus (including an amplifier). A CPU 11, which is provided in the fault diagnosis apparatus 1 according to the embodiment, is a processor that controls the fault diagnosis apparatus 1 as a whole, and reads a system program stored in a ROM 12 through a bus 20, thereby controlling the entire fault diagnosis apparatus 1 according to the system program. Temporary calculation data and display data are temporarily stored in a RAM 13.

For example, resulting from being backed up by a battery (not illustrated), a nonvolatile memory 14 is configured as a memory in which a stored state is held even though a power supply of the fault diagnosis apparatus 1 is turned off. The nonvolatile memory 14 stores data acquired through an input device such as a keyboard (not illustrated) or an external memory, a network and the like (including information at the occurrence of a fault of a motor drive apparatus to be repaired, operating information such as operating environment information and operating history information, test results at the tester, information on the replaced part, or the like); and a program for operations input through an interface (not illustrated), and the like. The program and various data stored in the nonvolatile memory 14 may be developed in the RAM 13 on execution or in use. Various system programs (including a system program for controlling interaction with a machine learning device 100 described later) are written into the ROM 12 in advance. Incidentally, the fault diagnosis apparatus 1 may be configured to be capable of acquiring, through the interface 18, the test results of the motor drive apparatus by a tester 70.

A graphics control circuit 15 converts digital signals such as numerical value data and graphics data into raster signals for display and sends the signals to a display device 60, and the display device 60 displays these numerical values and graphics. A liquid crystal display device is mainly used for the display device 60.

An interface 21 is an interface for connecting the fault diagnosis apparatus 1 and the machine learning device 100. The machine learning device 100 includes a processor 101 that controls the entire machine learning device 100, a ROM 102 that stores a system program and the like, a RAM 103 that performs temporary storage in each processing related to machine learning, and a nonvolatile memory 104 used for storing a learning model and the like. The machine learning device 100 is capable of observing each piece of the data (information at the occurrence of a fault of a motor drive apparatus to be repaired, and the like) that is acquirable by the fault diagnosis apparatus 1 through the interface 21. Also, the fault diagnosis apparatus 1 displays fault diagnosis results of parts configuring the motor drive apparatus to be repaired, which is output from the machine learning device 100, on a display device (not illustrated).

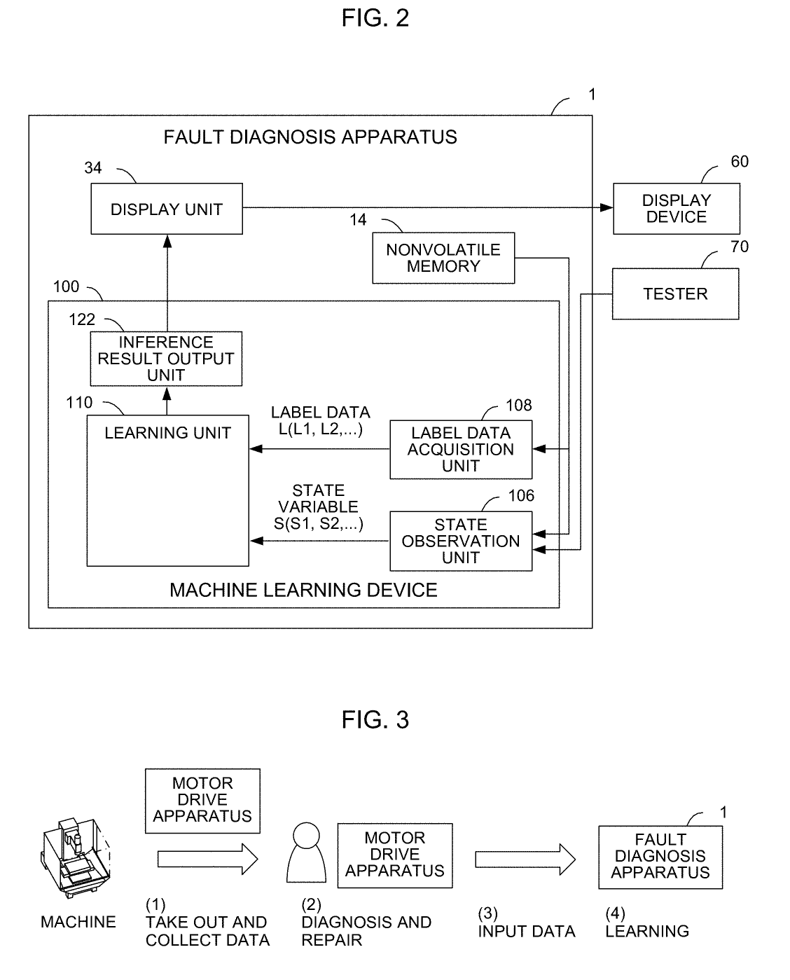

FIG. 2 is a schematic functional block diagram of the fault diagnosis apparatus 1 and the machine learning device 100 according to the first embodiment. The CPU 11, which is provided in the fault diagnosis apparatus 1 illustrated in FIG. 1, and the processor 101 of the machine learning device 100 execute each system program to control the operation of each unit of the fault diagnosis apparatus 1 and the machine learning device 100, thereby implementing each of functional blocks illustrated in FIG. 2.

The fault diagnosis apparatus 1 according to the embodiment includes a display unit 34 for outputting inference results output from the machine learning device 100 to the display device 60.

The machine learning device 100 according to the embodiment includes software (a learning algorithm or the like) and hardware (the processor 101 and or the like) for learning parts configuring the motor drive apparatus to be repaired, by so-called machine learning, with respect to a state of the motor drive apparatus to be repaired. What is learned by the machine learning device 100 provided in the fault diagnosis apparatus 1, corresponds to a model structure representing a correlation between a state of the motor drive apparatus to be repaired and a part to be repaired and/or replaced.

As illustrated in the functional blocks in FIG. 2, the fault diagnosis apparatus 1 is provided with the machine learning device 100, including: a state observation unit 106 that observes a state variable S including fault time point data S1 with information at the occurrence of a fault of the motor drive apparatus to be repaired, operating environment data S2 indicating an operating environment of the motor drive apparatus, and operating history data S3 indicating an operating history of the motor drive apparatus; a label data acquisition unit 108 that acquires label data L including repaired and/or replaced part data L1 indicating information on the repaired and/or replaced part; a learning unit 110 that performs learning by associating a part to be repaired and/or replaced with a state of the motor drive apparatus to be repaired, using the state variable S and the label data L; and further an inference result output unit 122 for outputting a determination result using the present learned model, based on information at the occurrence of a fault of the motor drive apparatus, an operating environment of the motor drive apparatus, and an operating history of the motor drive apparatus.

Out of the state variable S observed by the state observation unit 106, the fault time point data S1 is acquirable as a set of data indicating a state at the time point of a fault of the motor drive apparatus to be repaired. The fault time point data S1 includes, for example, alarm information generated in an incorporation destination at the time point of the fault of the motor drive apparatus, load information of the motor drive apparatus, temperature of the motor drive apparatus, time band at the occurrence of the fault, and the like. For each piece of the data, information or the like held in the memory at the time point of the fault of the driver of the motor drive apparatus may be acquired and used. The fault time point data S1 may be acquired and used from a machine incorporating the motor drive apparatus to be repaired, through an external storage device, a network, or the like.

Out of the state variable S, the operating environment data S2 is acquirable as a set of data indicating the operating environment of the motor drive apparatus before and after the fault of the motor drive apparatus to be repaired. The fault time point data S1 includes, for example, heat sink temperature, environmental temperature, environmental humidity, a used cutting fluid, installation location, a fault situation of other devices incorporated in the same axis as the motor drive apparatus, and the like. For each piece of the data, information held in a memory of a machine in which the motor drive apparatus is incorporated, information input by an operator performing maintenance, and the like may be acquired and used. The operating environment data S2 may be acquired and used from a machine, in which the motor drive apparatus to be repaired is incorporated, through an external storage device, a network, or the like.

Out of the state variable S, the operating history data S3 is acquirable as a set of data indicating the operating state of the motor drive apparatus to be repaired, until now. The operating history data S3 includes, for example, the operating time of the motor drive apparatus, the past repair history, and the like. For each piece of the data, information recorded on the memory of the motor drive apparatus, information recorded by a company performing maintenance, and the like may be acquired and used. The operating history data S3 may be acquired and used from a machine in which a motor drive apparatus to be repaired is incorporated, or from a database server or the like, in which a repair history is recorded, through an external storage device, a network, or the like.

For the repaired and/or replaced part data L1 included in the label data L acquired by the label data acquisition unit 108, for example, data related to the repair and replacement of apart reported by the operator performing the repair of the motor drive apparatus are usable. For example, the repaired and/or replaced part data L1 may include information on a part that is repaired and/or replaced with respect to the motor drive apparatus to be repaired, information on whether or not a fault phenomenon has been improved in the motor drive apparatus to be repaired, due to the replacement of the part, or the like. The label data L acquired by the label data acquisition unit 108 is an index indicating a result in a case where maintenance is performed under the state variable S.

The learning unit 110 learns the label data L with respect to an operating situation of the motor drive apparatus to be repaired, according to an optional learning algorithm collectively represented as machine learning. The learning unit 110 is capable of iteratively performing the learning based on a data set including the state variable S and the label data L described above.

FIG. 3 is a diagram illustrating a flow of performing machine learning by the learning unit 110, using the state variable S and the label data L.

Once an abnormality occurs in the motor drive apparatus incorporated in the machine, the operator, that has received a repair request, takes out the motor drive apparatus to be repaired from the machine, and various data (fault time point data S1, operating environment data S2, and operating history data S3) useful for fault diagnosis are acquired from the machine and the motor drive apparatus (a procedure (1)).

The operator tests the motor drive apparatus by using the tester 70, and the like while observing the appearance of the motor drive apparatus, estimates a faulty spot of the motor drive apparatus while referring to each piece of the data acquired in the procedure (1), and performs the repair and replacement of a part configuring the motor drive apparatus based on the estimated results (a procedure (2)).

Then, the operator confirming that the motor drive apparatus operates inputs various data obtained in the procedure (1) and information as to which part is repaired and/or replaced such that the motor drive apparatus becomes normal (repaired and/or replaced part data L1), into the fault diagnosis apparatus (a procedure (3)).

The fault diagnosis apparatus 1 performs machine learning using the state variable S and the label data L input by the operator (a procedure (4)).

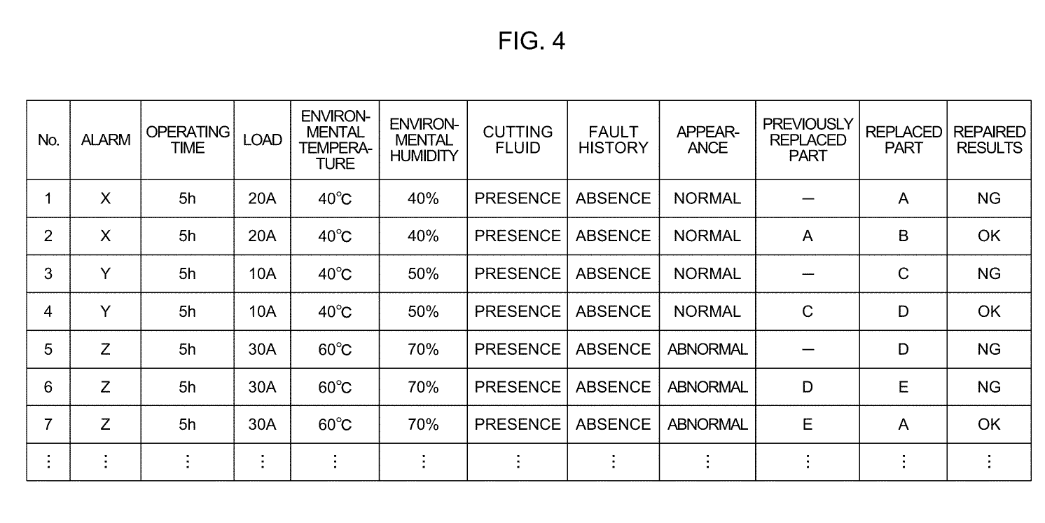

FIG. 4 illustrates an example of a data set of a state variable S and label data L acquired by the fault diagnosis apparatus 1 according to the embodiment. Incidentally, the example of the state variable S and the label data L in FIG. 4 simply illustrates a portion of each state data and label data L illustrated above.

In the example illustrated in FIG. 4, in a case where an abnormality occurs in a certain motor drive apparatus and an alarm X is generated in the machine in which the motor drive apparatus is incorporated, when part A is replaced, the abnormality of the motor drive apparatus is not recovered (No. 1), and thereafter, when part B is replaced, the motor drive apparatus is recovered normally (No. 2). In this case, the learning unit 110 performs machine learning using a data set (data set of No. 2, No. 4, and No. 7 in the example of FIG. 3) by which the motor drive apparatus is recovered normally.

By repeating such a learning cycle, the learning unit 110 is capable of automatically identifying a feature that implies correlation between any of the information (fault time point data S1) at the occurrence of the fault, the operating environment (operating environment data S2), and the operating history (operating history data S3), and a part to be repaired and/or replaced (repaired and/or replaced part data L1) with respect to the state.

At the start of the learning algorithm, the correlation between any of the fault time point data S1, the operating environment data S2, and the operating history data S3, and a part to be repaired and/or replaced is substantially unknown, but the learning unit 110 gradually identifies the feature and interprets the correlation in proceeding with the learning. Once the correlation between any of the fault time point data S1, the operating environment data S2, and the operating history data S3, and a part to be repaired and/or replaced is interpreted to a certain degree of reliable level, the learning results repeatedly output by the learning unit 110 allows a part to be repaired and/or replaced with respect to the present state, to be predicted with high accuracy.

Based on the results learned by the learning unit 110, the inference result output unit 122 performs inference of a state of the motor drive apparatus to be repaired and a part to be repaired and/or replaced, and outputs the inference results to the display unit 34. Once the state of the motor drive apparatus to be repaired is input to the machine learning device 100 in a state where learning by the learning unit 110 is completed, the inference result output unit 122 outputs a part to be repaired and/or replaced.

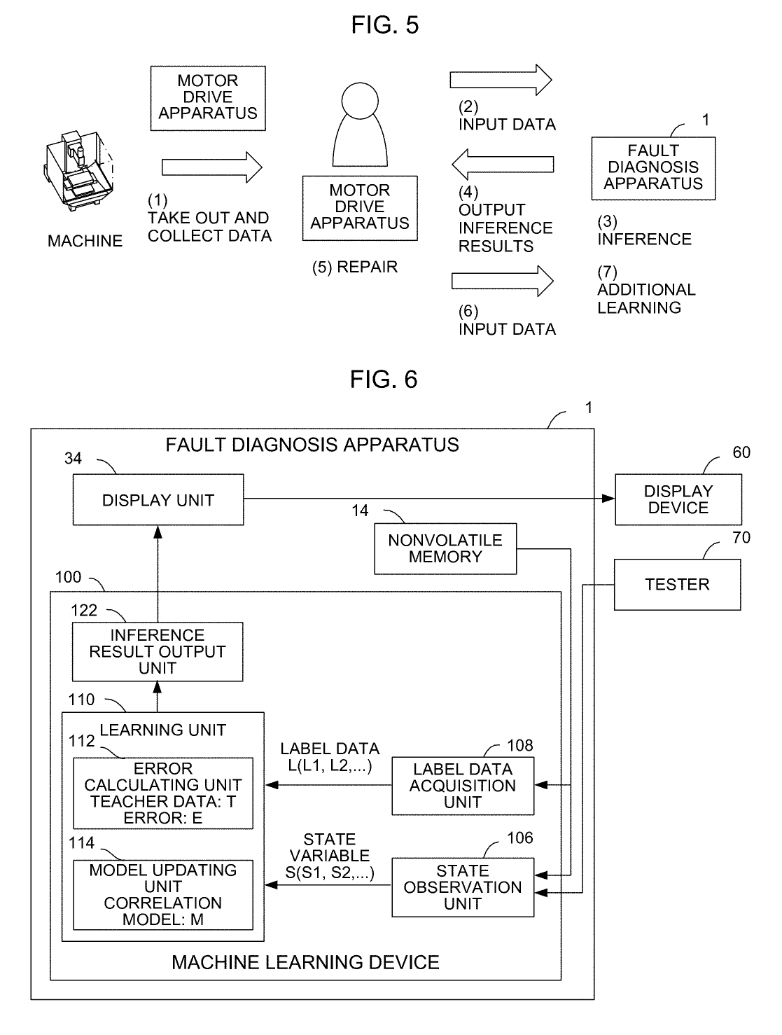

FIG. 5 is a diagram illustrating a flow of repairing the motor drive apparatus using the inference results by the fault diagnosis apparatus 1.

Once an abnormality occurs in the motor drive apparatus incorporated in the machine, the operator, that has received a repair request, takes out the motor drive apparatus to be repaired from the machine, and various data (fault time point data S1, operating environment data S2, and operating history data S3) useful for fault diagnosis are acquired from the machine and the motor drive apparatus (a procedure (1)).

The operator inputs the data acquired in the procedure (1) as a state variable S, to the fault diagnosis apparatus 1 (the procedure (2)).

The fault diagnosis apparatus 1 infers a part to be repaired and/or replaced of the motor drive apparatus, based on the state variable S input by the operator (the procedure (3)), and outputs the inference results (the procedure (4)).

The operator performs the repair or replacement of a part to be repaired and/or replaced outputted from the fault diagnosis apparatus 1, confirms whether or not the motor drive apparatus becomes normal (a procedure (5)), and in a case where the motor drive apparatus becomes normal, the repair is ended. On the other hand, in a case where the motor drive apparatus is not normal, the operator performs repair in a trial and error manner, and as a result, in a case where the motor drive apparatus becomes normal, the operator inputs the various data newly obtained by the procedure (1) and information as to which part is repaired and/or replaced such that the motor drive apparatus becomes normal (the repaired and/or replaced part data L1) (a procedure (6)).

Then, the fault diagnosis apparatus 1 performs (additional) machine learning using the state variable S and the label data L input by the operator (a procedure (7)). Incidentally, in a case where additional learning is not performed, the processing of the procedures (6) and (7) may be omitted.

As described above, in the machine learning device 100 provided in the fault diagnosis apparatus 1, by using the state variable S observed by the state observation unit 106 and the label data L acquired by the label data acquisition unit 108, the learning unit 110 performs learning of apart to be repaired and/or replaced, with respect to a state of the motor drive apparatus to be repaired, according to a machine learning algorithm. The state variable S is configured with data such as the fault time point data S1, the operating environment data S2, the operating history data S3, and test result data S4 that are not easily affected by disturbance. The label data L is acquirable from information input by the operator. Therefore, according to the machine learning device 100 provided in the fault diagnosis apparatus 1, by using the learning results of the learning unit 110, it is possible to automatically and further accurately infer a part to be repaired and/or replaced according to the state of the motor drive apparatus to be repaired.

As a modified example of the machine learning device 100 provided in the fault diagnosis apparatus 1, the state observation unit 106 further observes the test result data S4 indicating observation results of the motor drive apparatus or test results by the tester 70 and the like as the state variable S, and may use the test result data S4 for machine learning by the learning unit 110. The test result data S4 is acquirable as a set of data indicating the test results of the motor drive apparatus by the operator. The test result data S4 includes, for example, appearance (cutting fluid, chip adhesion state, and the like.), a current, heat generation, an encoder waveform, an internal state of the LSI, and the like. For each piece of the data, information input by an operator or acquired from the tester 70 may be used.

According to the modified example, the machine learning device 100 is capable of using the test result data S4 for learning and inferring, in addition to the fault time point data S1, the operating environment data S2, and the operating history data S3, so that the improvement of a system for inferring a part to be repaired and/or replaced is expectable.

As another modified example of the machine learning device 100 provided in the fault diagnosis apparatus 1, the label data acquisition unit 108 may further acquire re-repair time data L2 indicating an operating time until the next fault after repairing the motor drive apparatus and starting re-operation, and the next repaired and/or replaced part data L3 indicating information on a part to be repaired and/or replaced at the next fault, as label data L, and may use these data for machine learning by the learning unit 110. The re-repair time data L2 and the next repaired and/or replaced part data L3 may be acquired by recording an identifier capable of uniquely identifying each motor drive apparatus for each piece of the data acquired at the repair of the motor drive apparatus, and a temporal flow of a repair work of each motor drive apparatus, and by specifying an operating time until the next fault and information on the next repaired and/or replaced part, in a case where the learning of the repair of the motor drive apparatus is performed based on the data.

According to the modified example, the machine learning device 100 is capable of learning the re-repair time data L2 and the next repaired and/or replaced part data L3, in addition to the repaired and/or replaced part data L1, with respect to the state variable S (the fault time point data S1, the operating environment data S2, the operating history data S3, and the like), and is capable of inferring an operating time until a next fault after repairing the motor drive apparatus and starting re-operation, and a part to be repaired and/or replaced at the next fault, in addition to this time repaired and/or replaced part, based on the observed state variable S. Therefore, at the repair of the motor drive apparatus, the operator repairs or replaces the faulty part this time and performs testing and the like of a part that is likely to be faulty next time. Then, the operator can set up a maintenance plan to perform repair or replacement of the parts together as necessary, or to procure a part that is likely to be faulty during a period until the next fault timing.

As still another modified example of the machine learning device 100 provided in the fault diagnosis apparatus 1, the state observation unit 106 does not observe all of the fault time point data S1, the operating environment data S2, the operating history data S3, and the like as the state variable S, and may observe at least one of these state variables. In such a case, the learning unit performs learning by associating at least one of the fault time point data S1, the operating environment data S2, the operating history data S3, and the like observed by the state observation unit 106 with the label data L, and the inference result output unit 122 performs inference processing based on at least one of the fault time point data S1, the operating environment data S2, the operating history data S3, and the like observed by the state observation unit 106.

As described above, in a case where the machine learning device 100 is configured to observe at least one of the fault time point data S1, the operating environment data S2, the operating history data S3, and the like as the state variable S, it is possible to provide a fault diagnosis apparatus 1 for inferring a part to be repaired and/or replaced with respect to the state of the motor drive apparatus to be repaired with a certain degree of accuracy, although the accuracy of learning and inferring is reduced as compared with a case where all of these state variables are observed.

In the machine learning device 100 having such a configuration, the learning algorithm executed by the learning unit 110 is not particularly limited, and it is possible to adopt a known learning algorithm as machine learning. FIG. 6 illustrates a configuration as another embodiment of the fault diagnosis apparatus 1 illustrated in FIG. 2, which includes a learning unit 110 for performing supervised learning as another example of the learning algorithm. The supervised learning is a scheme of learning a correlation model in which a known data set (referred to as teacher data) of an input and an output corresponding to the input is provided, and a required output is estimated with respect to a new input by identifying a feature that implies the correlation between the input and the output from these teacher data.

In the machine learning device 100 provided in the fault diagnosis apparatus 1 illustrated in FIG. 6, the learning unit 110 includes an error calculating unit 112 for calculating an error E between a correlation model M for inferring a part to be repaired and/or replaced from the state variable S, and a correlation feature identified from preliminarily prepared teacher data T; and a model updating unit 114 for updating the correlation model M to reduce the error E. In the learning unit 110, by repeating the updating of the correlation model M, the model updating unit 114 learns a part to be repaired and/or replaced with respect to the state of the motor drive apparatus to be repaired.

The initial value of the correlation model M is, for example, expressed by simplifying (for example, by a linear function) the correlation between the state variable S and a part to be repaired and/or replaced, and is provided to the learning unit 110 before the start of supervised learning. For example, the teacher data T is configurable with experience values accumulated by recording the state of the motor drive apparatus to be repaired in the past and the history of repair by the operator, and is provided to the learning unit 110 before the start of supervised learning. From a large quantity of the teacher data T provided to the learning unit 110, the error calculating unit 112 identifies a correlation feature that implies correlation between a state of the motor drive apparatus to be repaired and a part to be repaired and/or replaced, and obtains an error E between the correlation feature and the correlation model M corresponding to the state variable S and the label data L in the present state. For example, the model updating unit 114 updates the correlation model M such that the error E is reduced according to a predetermined updating rule.

In the next learning cycle, the error calculating unit 112 predicts a part to be repaired and/or replaced using the state variable S according to the updated correlation model M and obtains the error E between the results of the prediction and the actually acquired label data L, and the model updating unit 114 updates the correlation model M again. In this way, a correlation between the present state and its prediction of the unknown environment becomes gradually obvious.

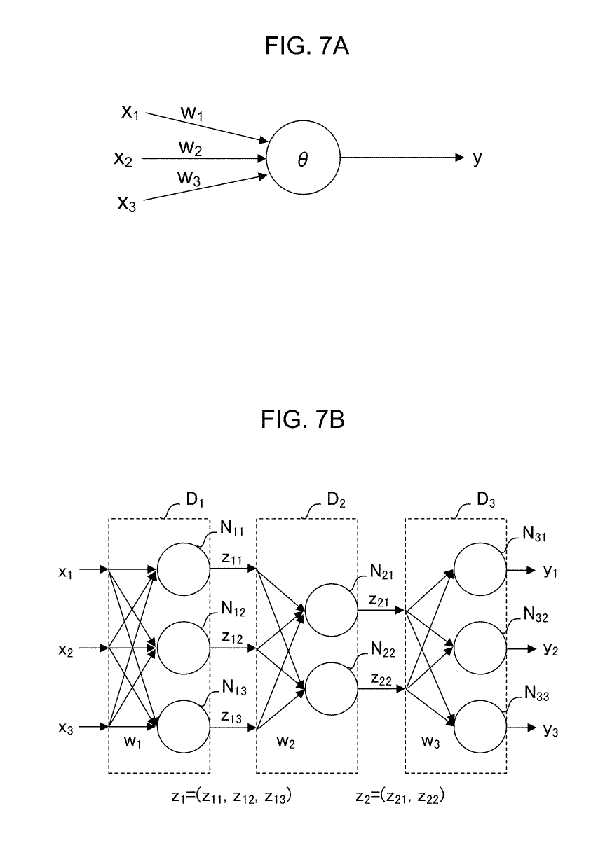

A neural network can be used when proceeding with the supervised learning described above. FIG. 7A schematically illustrates a model of a neuron. FIG. 7B schematically illustrates a model of a three-layer neural network configured by combining neurons illustrated in FIG. 7A. For example, the neural network is configurable with an arithmetic device, a storage device, and the like, imitating a model of a neuron.

The neuron illustrated in FIG. 7A outputs a result y for a plurality of inputs x (here, as an example, inputs x₁ to x₃). Each of the inputs x₁ to x₃ is multiplied by a weight w (w₁ to w₃) corresponding to this input x. As a result, the neuron outputs the result y expressed by Equation (1) below. In Equation (1), the input x, the result y and the weight w are all vectors. Also, θ is a bias and fₖ is an activation function.

y=fₖ(Σᵢ₌₁ⁿxᵢwᵢ−θ) (1)

In the three-layer neural network illustrated in FIG. 7B, a plurality of inputs x (here, as an example, inputs x1 to x3) are input from the left side and a result y (here, as an example, results y1 to y3) is output from the right side. In the illustrated example, each of the inputs x1, x2, and x3 is multiplied by a corresponding weight (collectively represented as w1), and each of the inputs x1, x2, and x3 is input to three neurons N11, N12, and N13.

The outputs of each of the neurons N11 to N13 are collectively represented as z1. The z1 can be regarded as a feature vector from which feature quantities of input vectors are extracted. In the illustrated example, each of elements of the feature vector z1 is multiplied by a corresponding weight (collectively represented as w2), and each of the individual elements of the feature vector z1 is input to two neurons N21 and N22. The feature vector z1 represents a feature between the weight W1 and the weight W2.

The outputs of each of the neurons N21 and N22 are collectively represented as z2. The z2 can be regarded as a feature vector from which feature quantities of the feature vector z1 are extracted. In the illustrated example, each of elements of the feature vector z2 is multiplied by a corresponding weight (collectively represented as w3), and each of the individual elements of the feature vector z2 is input to three neurons N31, N32, and N33. The feature vector z2 represents a feature between the weight W2 and the weight W3. Finally, the neurons N31 to N33 output results y1 to y3, respectively.

It is also possible to use a so-called deep learning scheme using a neural network for three or more layers.

In the machine learning device 100 provided in the fault diagnosis apparatus 1, the learning unit 110 is capable of performing the calculation of the multilayer structure according to the neural network described above, using the state variable S as the input x, and is capable of outputting information as to which part is required to be repaired and/or replaced among parts configuring the motor drive apparatus to be repaired (result y). An operation mode of the neural network includes a learning mode and a value prediction mode. For example, the weight w may be learned using a learning data set in the learning mode, and a value of an action is determinable in the value prediction mode using the learned weight w. In the value prediction mode, it is possible to perform detection, classification, inference, and the like.

The configuration of the fault diagnosis apparatus 1 described above can be described as a machine learning method (or software) executed by the processor 101. This machine learning method is a machine learning method of learning apart to be repaired and/or replaced, by the processor 101, which includes steps of:

observing data such as the fault time point data S1, the operating environment data S2, the operating history data S3, and the like as a state variable S representing the present state;

acquiring label data L indicating the results of the repair and replacement of the parts of the motor drive apparatus; and performing learning by associating any of the fault time point data S1, the operating environment data S2, and the operating history data S3 with a part to be repaired and/or replaced, using the state variable S and the label data L.

The learned model learned and obtained by the learning unit 110 of the machine learning device 100 may be used as a program module which is a part of software related to machine learning. The learned model according to the embodiments is usable in a computer including a processor such as a CPU or a graphics processing unit (GPU), and a memory. More specifically, the processor of the computer operates to perform calculation by inputting the state of the motor drive apparatus as an input according to a command from the learned model stored in the memory, and to output a part to be repaired and/or replaced based on the calculation results.

The learned model according to the embodiments is usable by being duplicated to another computer through an external storage medium, a network, and the like.

Also, in a case where the learned model according to the embodiments is copied to another computer and used in a new environment, it is possible to perform further learning of the learned model, based on new state variables and determination data obtained in the environment. In such a case, it is possible to obtain a learned model (hereinafter, referred to as a derived model) derived from the learned model based on the environment. The derived model according to the embodiments is the same as an original learned model in that the results obtained by inferring a part to be repaired and/or replaced with respect to the state of a predetermined motor drive apparatus, are output, but the derived model is different from the original learned model in that the results suitable for a new environment (for example, a motor-driven part of a new type), as compared with the original learned model, are output. This derived model is usable by being duplicated to another computer through an external storage medium, a network, and the like.

Further, a learned model obtained by performing learning from the beginning in another machine learning device (hereinafter, referred to as a distillation model) may be created using an output obtained with respect to an input to the machine learning device incorporating the learned model of the embodiments, and used (such learning processing is referred to as distillation). In distillation, the original learned model is called a teacher model, and the newly created distillation model is called a student model. In general, the distillation model is smaller in size than the original learned model. However, the distillation model may provide the same accuracy as that of the original learned model, and thus is more suitable for distribution to another computer through an external storage medium, a network, and the like.

Even though the embodiments have been described above, the embodiments are not limited only to examples of the above-described embodiments, and can be implemented in various modes by making appropriate changes.

For example, the learning algorithm or calculation algorithm executed by the machine learning device 100 are not limited to those described above, and various algorithms can be adopted.

In the embodiments described above, the fault diagnosis apparatus 1 and the machine learning device 100 are described as those having different CPUs, but the machine learning device 100 may be implemented by the CPU 11 provided in the fault diagnosis apparatus 1 and the system program stored in the ROM 12.

In the embodiments described above, even though there is illustrated an example in which the machine learning device 100 is provided in the fault diagnosis apparatus 1, the machine learning device 100 may be configured to be provided in a cloud server or the like prepared in the network.

Further, in the embodiments described above, the machine learning device 100 performs machine learning to infer and output a part to be repaired and/or replaced with respect to the state of the motor drive apparatus. However, it is also possible to display a part to be repaired and/or replaced in ascending order of probability, for example, by configuring the learning unit 110 as a well-known convolutional neural network (CNN) and the like, regarding a part to be repaired and/or replaced as a class by a label, and performing machine learning such that the probability of belonging to each class is output on an output side. In such a configuration, the operator initially repairs and replaces a part with the highest probability based on the output from the fault diagnosis apparatus 1, and in a case where the motor drive apparatus does not become normal, the operator repairs and replaces a part with the next highest probability, so that the repair work of the motor drive apparatus may be more flexibly supported.

1. A fault diagnosis apparatus for inferring a part to be repaired and/or replaced of a motor drive apparatus, comprising:
a machine learning device for learning a part to be repaired and/or replaced with respect to a state of the motor drive apparatus to be repaired,
wherein the machine learning device includes
a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment;
a label data acquisition unit for acquiring repaired and/or replaced part data indicating a part that has been repaired and/or replaced in the motor drive apparatus as label data; and
a learning unit for performing learning by associating the state variable with the label data.

2. The fault diagnosis apparatus according to claim 1,
wherein the state observation unit further observes test result data indicating test results of the motor drive apparatus as a state variable.

3. The fault diagnosis apparatus according to claim 1,
wherein the label data acquisition unit further acquires re-repair time data indicating an operating time until a next fault after repairing the motor drive apparatus and starting re-operation, and the next repaired and/or replaced part data indicating information on a part to be repaired and/or replaced at the next fault as label data.

4. The fault diagnosis apparatus according to claim 1,
wherein the learning unit includes an error calculating unit for calculating an error between a correlation model for inferring the part to be repaired and/or replaced from the state variable and a correlation feature identified from preliminarily prepared teacher data; and
a model updating unit for updating the correlation model to reduce the error.

5. The fault diagnosis apparatus according to claim 1,
wherein the learning unit calculates the state variable and the label data in a multilayer structure.

6. The fault diagnosis apparatus according to claim 1,
wherein the machine learning device is provided in a cloud server.

7. A fault diagnosis apparatus for inferring a part to be repaired and/or replaced of a motor drive apparatus, comprising:
a machine learning device for learning a part to be repaired and/or replaced with respect to a state of the motor drive apparatus to be repaired,
wherein the machine learning device includes
a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment;
a learning unit for performing learning by associating a part that has been repaired and/or replaced in the motor drive apparatus with information at the occurrence of a fault of the motor drive apparatus, an operating environment of the motor drive apparatus, and an operating history of the motor drive apparatus; and
an inference result output unit for outputting the results obtained by inferring the part to be repaired and/or replaced, based on a state variable observed by the state observation unit and learning results by the learning unit.

8. A machine learning device for learning a part to be repaired and/or replaced with respect to an operating situation of a motor drive apparatus to be repaired, comprising:
a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment;
a label data acquisition unit for acquiring repaired and/or replaced part data indicating a part that has been repaired and/or replaced in the motor drive apparatus as label data; and
a learning unit for performing learning by associating the state variable with the label data.

9. A machine learning device for learning a part to be repaired and/or replaced with respect to a state of the motor drive apparatus to be repaired, comprising:
a state observation unit for observing at least one of fault time point data including information at the occurrence of a fault of the motor drive apparatus, operating environment data indicating an operating environment of the motor drive apparatus, and operating history data indicating an operating history of the motor drive apparatus, as a state variable representing the present state of the environment;
a learning unit for performing learning by associating apart that has been repaired and/or replaced in the motor drive apparatus with information at the occurrence of a fault of the motor drive apparatus, an operating environment of the motor drive apparatus, and an operating history of the motor drive apparatus; and
an inference result output unit for outputting the results obtained by inferring the part to be repaired and/or replaced, based on a state variable observed by the state observation unit and learning results by the learning unit.
